(19) United States
(12) Patent Application Publication
(10) Pub. No.: US 2026/0254124 A1
(43) Pub. Date: Aug. 27, 2026

(54) ANTENNAS HAVING LENSES FORMED OF LIGHT WEIGHT DIELECTRIC RODS AND/OR META-MATERIAL, UNIT CELL STRUCTURES COMPRISING META-MATERIAL AND METHODS OF FORMING LENSES

(71) Applicant: Outdoor Wireless Networks LLC, Claremont, NC (US)

(72) Inventors: Zeeshan Qamar, Richardson, TX (US); Björn Lindmark, Sollentuna (SE)

(21) Appl. No.: 18/879,421

(22) PCT Filed: Jun. 20, 2023
(86) PCT No.: PCT/US2023/068715

§ 371 Date: Dec. 27, 2024

Related U.S. Application Data
(60) Provisional application No. 63/371,532, filed on Aug. 16, 2022.

(51) Int. Cl. H01Q 15/00; H01Q 15/10; H01Q 19/06

(52) U.S. Cl. CPC H01Q 15/0086; H01Q 15/10; H01Q 19/062

(57) ABSTRACT

Lensed antennas are provided that include a plurality of radiating elements and a lens positioned to receive electromagnetic radiation from at least one of the radiating elements, the lens comprising a plurality of rods. The rods include dielectric material and/or unit cell structures with three-dimensional meta-material patterns. The rods can be formed of stacked rod members. The stacked rod members can be formed by a stacked series of the unit cell structures. The rods can have the same size and materials with different spacings, the same size and spacing and different materials, or different sizes with the same or different spacing, each configuration arranged to define different effective permittivities across a diameter of the lens.

### RELATED APPLICATIONS

This patent application claims the benefit of and priority to U.S. Provisional Application Ser. No. 63/371,532, filed Aug. 16, 2022, the contents of which are hereby incorporated by reference as if recited in full herein.

### BACKGROUND

The present invention generally relates to radio communications and, more particularly, to lensed antennas utilized in cellular and other communications systems.

Cellular communications systems are well known in the art. In a cellular communications system, a geographic area is divided into a series of regions that are referred to as “cells,” and each cell is served by a base station. The base station may include one or more antennas that are configured to provide two-way radio frequency (“RF”) communications with mobile subscribers that are geographically positioned within the cells served by the base station. In many cases, each base station provides service to multiple “sectors,” and each of a plurality of antennas will provide coverage for a respective one of the sectors. Typically, the sector antennas are mounted on a tower or other raised structure, with the radiation beam(s) that are generated by each antenna directed outwardly to serve the respective sector.

A common wireless communications network plan involves a base station serving three hexagonally shaped cells using three base station antennas. This is often referred to as a three-sector configuration. In a three-sector configuration, each base station antenna serves a 120° sector. Typically, each base station antenna is configured to generate antenna beams having a 65° azimuth Half Power Beamwidth (HPBW) antenna, which provide good coverage for a 120° sector. Three of these 120° sectors provide 360° coverage. Other sectorization schemes may also be employed. For example, six, nine, and twelve sector configurations are also used. Six sector sites may involve six directional base station antennas, each having a 33° azimuth HPBW antenna serving a 60° sector. In other proposed solutions, so-called “sector splitting” antennas may be used that have a single, multi-column array that is driven by a feed network to produce two or more antenna beams from a single phased array antenna that point in different directions. For example, if sector-splitting antennas are used that each generate two beams, then only three antennas may be required for a six-sector configuration. Antennas that generate multiple beams are disclosed, for example, in U.S. Patent Publication No. 2011/0205119, which is incorporated herein by reference.

Increasing the number of sectors increases system capacity because each antenna can service a smaller area and therefore provide higher antenna gain throughout the sector and because frequency bands may be reused for each sector. However, dividing a coverage area into smaller sectors has drawbacks because antennas covering narrow sectors generally have more columns of radiating elements than do antennas covering wider sectors. For example, a typical twin-beam sector splitting antenna uses four columns of radiating elements to generate two 33° azimuth HPBW antenna beams whereas a single column of radiating elements can generate a 65° azimuth HPBW antenna beam.

Lenses may be used in cellular and other communications systems to focus an antenna beam, which can be useful for increasing the number of sectors served by a cellular base station. For example, a twin beam sector splitting base station antenna can be formed using two columns of radiating elements and a lens. Lenses, however, may increase the cost, weight and/or complexity of the antenna and hence may not provide commercially practical solutions in many antenna applications.

### SUMMARY

Pursuant to embodiments of the present invention, antennas are provided that include a plurality of radiating elements and a lens positioned to receive electromagnetic radiation from at least one of the radiating elements. The lens includes a plurality of elongate rods that extend longitudinally about at least a major portion of a length dimension of the lens.

Embodiments of the invention are directed to a lensed antenna that includes: an array of radiating elements; and a lens positioned to receive electromagnetic radiation from at least one of the radiating elements. The lens includes a plurality of elongate rods that are spaced apart and that extend longitudinally along at least a major portion of a length dimension of the lens and about at least a major portion of an X-Y plane of the lens with the X-Y plane being perpendicular to the length dimension. The elongate rods are dielectric and/or have a plurality of unit cell structures, each unit cell structure comprising meta-material in a three-dimensional pattern.

The lens can cylindrical. At least some of the plurality of elongate rods can be radially and circumferentially spaced apart across an entire diameter of the lens.

At least some of the plurality of elongate rods can be arranged in a plurality of rings.

At least 70% of the elongate rods can be arranged in the plurality of rings and extend between an axially extending center of the lens to an outer diameter thereof.

At least some of the elongate rods are formed by a plurality of respective rod members that are longitudinally stacked.

The plurality of rod members can be cylindrical.

The elongate rods can be provided as a first plurality of rings positioned at an inner region of the lens and having a first spacing between circumferentially neighboring elongate rods. The first plurality of rings can be surrounded by a second plurality of rings having a second spacing between circumferentially neighboring elongate rods. The second spacing can be greater than the first spacing. The second plurality of rings can be surrounded by a third plurality of rings having a third spacing between circumferentially neighboring elongate rods. The third spacing can be greater than the second spacing.

The elongate rods can have a common size, shape and material. The first, second and third spacings can define different effective permittivities.

A first plurality of the elongate rods have a first permittivity. A second plurality of the elongate rods surround the first plurality of the elongate rods and have a second permittivity that is different than the first permittivity. The second plurality of the elongate rods can be surrounded by a third plurality of the elongate rods that have a third permittivity that is different than the first and second permittivities thereby providing a change in effective permittivity across a diameter of the lens.

The first, second and third plurality of the elongate rods can be arranged to have a common spacing between at least a major portion of neighboring elongate rods across the diameter of the lens.

The elongate rods can be (heterogeneous) dielectric rods.

The elongate rods can have the unit cell structures with the meta-material in the three-dimensional pattern.

The unit cell structures can be provided as a stacked series of unit cell structures forming a respective elongate rod member.

The unit cell structures can have a cubic meta-material structure with the three-dimensional meta-material pattern comprising six rings, each of the six rings on a different one of six primary surfaces of the cubic meta-material structure.

The meta-material in the three-dimensional pattern can have a cylindrical wall with four circumferentially spaced apart rings, optionally between opposing end rings.

The four circumferentially spaced apart rings can be oval.

The unit cell structure can have a dielectric material that encapsulates the three-dimensional meta-material pattern.

The unit cell structures can be rectangular and can have a low-loss center and a dielectric outer surface, with the three-dimensional meta-material pattern sandwiched therebetween.

The unit cell structures can have a rollable substrate with a two-dimensional meta-material pattern that is rolled to define a cylindrical body shape comprising three-dimensional meta-material pattern.

In the rolled configuration providing the cylindrical body, free ends of the rollable substrate are electrically decoupled.

Other embodiments are directed to methods of manufacturing a lens for an antenna. The methods include providing a plurality of elongate rods. The rods have a dielectric material and/or unit cell structures with a three-dimensional pattern of meta-material. The methods include arranging the elongate rods to extend longitudinally a length of a body of the lens and spaced apart across a diameter thereof; and forming a cylindrical lens comprising the elongate rods.

The arranging can be carried out so that at least some of the elongate rods are arranged in a plurality of rings that extend between a center and an outer diameter of the lens body.

At least a plurality of the rings can be concentric.

The elongate rods can have the dielectric material. The providing the elongate rods can be carried out by forming at least some of the elongate rods by stacking a series of longitudinally discrete dielectric rod members into a column to form a respective elongate rod.

The arranging the elongate rods into the plurality of rings can include: arranging a first plurality of rings at an inner region of the lens with a first spacing between circumferentially neighboring elongate rods; arranging a second plurality of rings to surround the first plurality of rings, with the second plurality of having a second spacing between circumferentially neighboring elongate rods, with the second spacing being greater than the first spacing; and arranging a third plurality of rings to surround the second plurality of rings, with the third plurality of rings having a third spacing between circumferentially neighboring elongate rods, with the third spacing is greater than the second spacing.

The elongate rods can have a common size, shape and material. The first, second and third spacings are configured to define different effective permittivities across a diameter of the lens.

The arranging the elongate rods into the plurality of rings can include providing a first plurality of rings of the elongate rods with a first permittivity, providing a second plurality of the elongate rods that surround the first plurality of elongate rods, the second plurality of the elongate rods having a second permittivity that is different than the first permittivity, and providing a third plurality of the elongate rods that surround the second plurality of the elongate rods, the third plurality of the elongate rods having a third permittivity that is different than the first and second permittivities thereby providing a change in effective permittivity across a diameter of the lens.

The elongate rods can be provided with the unit cell structures. The providing the elongate rods can be carried out by forming at least some of the elongate rods by stacking a series of the unit cell structures to form a respective elongate rod.

The three-dimensional meta-material pattern can have six rings oriented on or in six different primary surfaces of a cubic structure.

The three-dimensional pattern of meta-material can have four circumferentially spaced apart rings.

The four circumferentially spaced apart rings can be positioned between opposing circular end rings.

The four circumferentially spaced apart rings can be oval.

The unit cell structures can be configured to encapsulate the meta-material.

The unit cell structures can be rectangular and can have a low-loss material center and a dielectric outer surface, with the meta-material sandwiched therebetween.

The elongate rods can be provided as the unit cell structures. The method can further include forming the unit cell structures by rolling a film having a two-dimensional meta-material pattern into a cylindrical form to define the three-dimensional meta-material pattern.

In an unrolled state, the two-dimensional meta-material pattern can have first and second spaced apart straight lines with a plurality of rings therebetween.

Still other embodiments are directed to a unit cell structure that includes: a cubic structure having six primary surfaces; and a meta-material pattern on the cubic structure. The meta-material pattern has six rings with one of the six rings on each one of the six primary surfaces of the cubic structure.

The six rings can have the same size and shape and define an isotropic structure. A unit cell is defined by an outer box forming the cubic structure of a first elongate rod and a corresponding half of an immediate air volume between the unit cell and a neighboring elongate rod in each direction with a permittivity in a range of 1-2.

The six rings have a thickness defined in an X-Y plane that is in a range of 17 micrometers to 35 micrometers and a diameter in a range of 1 mm to 25 mm.

The cubic structure with the meta-material pattern can be held by a larger outer box of dielectric material. The outer box can have a maximum width/height/depth dimension that is in a range of 10 mm to 35 mm, and/or the cubic structure has a maximum width/height/depth dimension that is in a range of 5 mm to 30 mm.

Still other embodiments are directed to a unit cell structure that includes: a cylindrical structure comprising an axially extending centerline and an axially extending cylinder wall; and a meta-material pattern on the cylinder wall. The meta-material pattern has four circumferentially extending and spaced apart rings.

The meta-material pattern can further include first and second end rings on the cylinder wall.

The four rings can have an oval shape.

The four rings can have a thickness defined in an X-Y plane that is in a range of 17 micrometers to 35 micrometers and a diameter in a range of 1 mm to 25 mm.

The unit cell structure with the cylindrical structure can be defined by an outer box surrounding the cylindrical structure forming a segment of a first elongate rod and a corresponding half of an immediate air volume between the unit cell structure and a neighboring elongate rod in each direction, wherein the outer box has maximum width/height that is in a range of 10 mm to 35 mm.

### BRIEF DESCRIPTION OF THE DRAWINGS

FIG. 1 is a schematic side perspective view of a portion of a RF lens for an antenna, the RF lens including a plurality of elongate rods according to embodiments of the present invention.

FIG. 2 is a top view of the portion of the RF lens shown in FIG. 1.

FIG. 3 is an enlarged top (or bottom) view of one elongate rod shown in FIG. 2 that illustrates the structure in greater detail.

FIG. 4 is a simulated E field (dB) graph of the top view of the portion of the RF lens shown in FIG. 2.

FIG. 5A is a schematic illustration of different effective permittivity regions of the RF lens shown in FIGS. 1 and 2 with five different permittivity regions provided by the diameter, spacing and/or material of the elongate rods according to embodiments of the present invention.

FIG. 5B is a table of the different regions (layers) shown in FIG. 5A with respective example effective permittivity and spacing “p” (mm) according to embodiments of the present invention.

FIG. 6 is a simulated graph of gain (dB) versus phase/degree of the portion of the RF lens shown in FIGS. 1 and 2.

FIG. 7 is a schematic side perspective view of another example portion of a RF lens for an antenna, the RF lens including a plurality of elongate rods according to embodiments of the present invention.

FIG. 8 is a top view of the portion of the RF lens shown in FIG. 7.

FIG. 9 is an enlarged top (or bottom) view of one elongate rod shown in FIG. 8 that illustrates the structure in greater detail.

FIG. 10 is a simulated E field (dB) graph of the top view of the portion of the RF lens shown in FIG. 7.

FIG. 11A is a schematic illustration of different effective permittivity regions of the RF lens shown in FIGS. 7 and 8 with five different permittivity regions provided by the diameter, spacing and/or material of the elongate rods according to embodiments of the present invention.

FIG. 11B is a table of the different regions (layers) shown in FIG. 11A with respective example effective permittivity of different permittivity elongate rods at the different layers/regions according to embodiments of the present invention.

FIG. 11C is a simulated graph of gain (dB) versus phase/degree of the portion of the RF lens shown in FIGS. 7 and 8.

FIG. 12A is a schematic top view of another portion of an RF lens with circumferentially offset elongate rods in adjacent rings according to other embodiments of the present invention.

FIG. 12B is a schematic top view of another portion of an RF lens with different diameter elongate rods in different regions according to other embodiments of the present invention.

FIG. 13 is a schematic perspective view illustrating a unit cell structure of a rod member comprising meta-material for an RF lens according to embodiments of the present invention.

FIG. 14 is a side view of the unit cell structure shown in FIG. 13.

FIG. 15 is a schematic of a directional axes for the unit cell structure shown in FIG. 13.

FIGS. 16 and 17 are simulated graphs of permittivity versus frequency (GHz) at different angles for a portion of an RF lens using the unit cell structure shown in FIGS. 13 and 14.

FIG. 18 is a simulated graph of permittivity versus angle for H-polarization and V-polarization for a portion of an RF lens using the unit cell structure shown in FIGS. 13 and 14.

FIG. 19 is a schematic perspective view illustrating another example unit cell structure of a rod member comprising meta-material for an RF lens according to embodiments of the present invention.

FIG. 20 is a side view of the unit cell structure shown in FIG. 19.

FIG. 21 is a schematic of a directional axes for the unit cell structure shown in FIG. 19.

FIG. 22 is a simulated graph of permittivity versus angle for H-polarization and V-polarization for a portion of an RF lens using the unit cell structure shown in FIGS. 20 and 21.

FIG. 23A is a perspective view of the unit cell structure shown in FIG. 19 but oriented in a different direction using the same directional axes shown in FIG. 21 according to embodiments of the present invention.

FIG. 23B is a side view of the unit cell structure and orientation shown in FIG. 23A.

FIG. 23C is a simulated graph of permittivity versus angle for H-polarization and V-polarization of a portion of an RF lens using the unit cell structure and orientation shown in FIGS. 23A and 23B.

FIG. 24A is a side perspective view of an example RF lens for an antenna comprising elongate stackable rod members according to embodiments of the present invention.

FIG. 24B illustrates one example elongate rod of the RF lens shown in FIG. 24A.

FIG. 24C illustrates one example rod member shown in FIGS. 24A and 24B according to embodiments of the present invention.

FIG. 25A is a side perspective view of an example RF lens for an antenna comprising elongate stackable rod members that have unit cell structures comprising meta-material according to embodiments of the present invention.

FIG. 25B illustrates one example elongate rod of the RF lens shown in FIG. 24A.

FIG. 25C illustrates one example rod member with a unit cell structure comprising meta-material shown in FIGS. 25A and 25B according to embodiments of the present invention.

FIG. 26 is a side perspective view of an embodiment of a rollable unit cell structure provided by a planar substrate such as film having a pattern of meta-material thereon according to embodiments of the present invention.

FIG. 27 is side perspective view of the planar substrate shown in FIG. 26 partially formed into a unit cell structure according to embodiments of the present invention.

FIG. 28 illustrates the planar substrate shown in FIG. 26 in a rolled configuration forming the unit cell structure with the pattern of meta-material according to embodiments of the present invention.

FIG. 29 is a side perspective view of another example embodiment of a unit cell structure comprising a pyramid shape with meta-material on primary surfaces thereof according to embodiments of the present invention.

FIGS. 30 and 31 are side perspective views of yet other example embodiments of a unit cell structure comprising a meandering meta-material ring or loop pattern according to embodiments of the present invention.

FIG. 32A is a side perspective view of a foam core that can be used to support and form the RF lens with the elongate rods according to embodiments of the present invention.

FIG. 32B is a side perspective view of cooperating disks with preformed apertures that can be used to assemble the elongate rods to form the RF lens according to embodiments of the present invention.

FIG. 33A is a perspective view of a lensed multi-beam antenna according to embodiments of the present invention.

FIG. 33B is a cross-sectional view of the lensed multi-beam antenna shown in FIG. 33A.

### DETAILED DESCRIPTION

Sector-splitting antennas have Butler Matrix based beam forming networks that drive a planar array of radiating elements to generate multiple antenna beams. Such beam forming networks, however, have several potential disadvantages, including non-symmetrical beams and problems associated with port-to-port isolation, gain loss, and/or a narrow bandwidth. Multi-beam antennas have also been proposed that use Luneburg lenses, which are multi-layer lenses, typically spherical in shape, that have dielectric materials having different dielectric constants in each layer. Unfortunately, the costs of Luneburg lenses is prohibitively high for many applications, and antenna systems that use Luneburg lenses may still have problems in terms of beam width stability over a wide frequency band.

U.S. Patent Publication No. 2015/0091767 (“the '767 publication”) proposes a multi-beam antenna that has linear arrays of radiating elements and a cylindrical RF lens that is formed of a composite dielectric material. The RF lens is used to focus the antenna beams generated by the linear arrays in the azimuth plane. In an example embodiment, the 3 dB azimuth beam width of a linear array may be reduced from 65° without the lens to 23° with the lens. The entire contents of the '767 publication are incorporated herein by reference. The cylindrical RF lens of the '767 publication, however, may be quite large, increasing the size, weight and cost of an antenna system using such a lens. In addition, cylindrical lenses may exhibit reduced cross-polarization performance which may be undesirable in applications where the antennas transmit and receive signals having two orthogonal polarizations such as slant +45°/−45° polarizations.

The lens disclosed in the '767 publication differs from a conventional Luneburg lens in that the dielectric constant of the material used to form the lens may be the same throughout the lens, in contrast with the Luneburg lens design in which multiple layers of dielectric material are provided where each layer has a different dielectric constant. A cylindrical lens having such a homogenous dielectric constant may be easier and less expensive to manufacture. The lenses of the '767 publication may be made of small blocks of a composite dielectric material. The dielectric material focuses the RF energy that radiates from, and is received by, the linear arrays. The '767 publication teaches that the dielectric material may be a composite dielectric material of the type described in U.S. Pat. No. 8,518,537 (“the '537 patent”), the entire contents of which is incorporated herein by reference. In one example embodiment, small blocks of the composite dielectric material are provided, each of which includes at least one needle-like conductive fiber embedded therein. The small blocks may be formed into a much larger structure using an adhesive that glues the blocks together. The blocks may have a random orientation within the larger structure. The composite dielectric material used to form the blocks may be a lightweight material having a density in the range of, for example, 0.005 to 0.1 g/cm³. By varying the number and/or orientation of the conductive fiber(s) that are included inside the small blocks, the dielectric constant of the material can be varied from 1 to 3.

Unfortunately, the composite dielectric material used in the lens of the '767 publication may be expensive to manufacture. Moreover, because the composite dielectric material includes conductive fibers, it may be a source of passive intermodulation (“PIM”) distortion that can degrade the quality of the communications if inconsistent metal-to-metal contacts are formed between different conductive fibers. Additionally, the conductive fibers included in adjacent small blocks of material may become electrically connected to each other resulting in larger particle sizes that can negatively impact the performance of the lens.

Pursuant to embodiments of the present invention, antennas suitable for use as base station antennas are provided that include lenses formed of light weight discrete elongate rods that are dielectric and/or comprise meta-material that replace conventional layers in Luneberg lens and that can be easier to manufacture and that can mitigate over-heating that may occur in a center part of the lens.

The elongate rods can be formed by dielectric materials which may also be low-loss materials. The imaginary part of the complex representation of the permittivity of a dielectric material is related to the rate at which energy is absorbed by the material. The absorbed energy reflects the “loss” of the dielectric material, since absorbed energy is not radiated. Low-loss dielectric materials are desirable for use in lenses for antennas as it is desirable to reduce or minimize the amount of RF energy that is lost in transmitting the signal through the lens. As will be discussed further below, the elongate rods may comprise stackable rod members that may include unit cell structures of meta-material in some embodiments.

A number of competing concerns may be weighed when designing an RF lens for a lensed base station antenna. Tower loading is a concern since a heavier antenna requires more robust support structures (which increases cost) and may be more difficult to install. Accordingly, all else being equal, lighter RF lens material is generally preferred. Additionally, RF losses are preferably kept to a minimum, which means the lens material should be relatively low loss throughout the frequency range at which the antenna is designed to operate. The lens material also preferably is relatively PIM-free as any PIM generated in the RF lens may significantly deteriorate the performance of the entire RF system. The RF lens material is also preferably relatively low cost, and should have a dielectric constant that is useful for focusing RF energy in the operating frequency range of the antenna. The dielectric constant of the RF lens also preferably maintains suitable uniformity throughout the RF lens to provide consistent focusing of the RF energy.

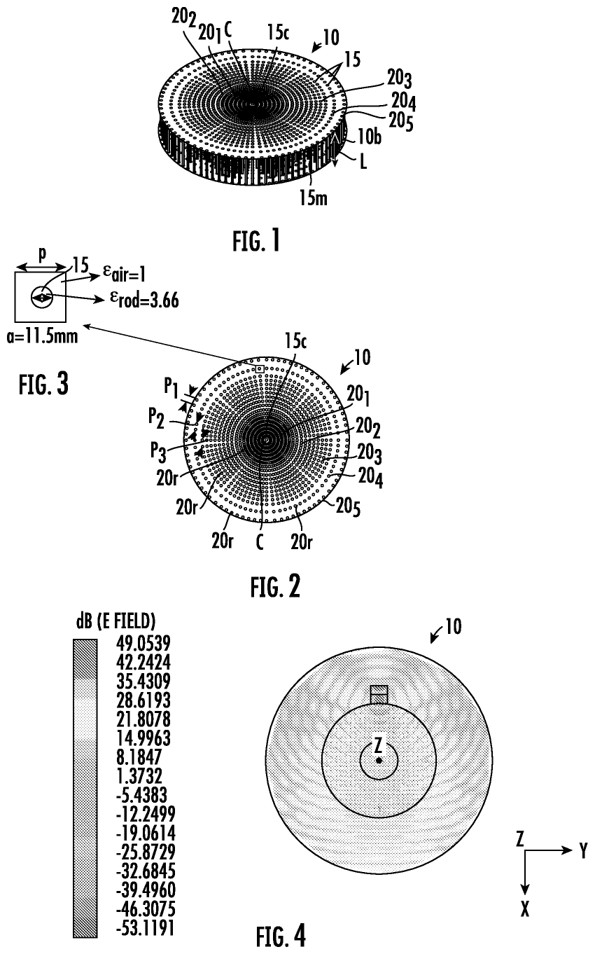

Referring to FIGS. 1 and 2, a portion of an RF lens 10 is shown. The RF lens 10 has a plurality of elongate rods 15. The plurality of elongate rods 15 can be circumferentially and radially spaced apart across a diameter of the lens body 10b.

The plurality of elongate rods 15 can be provided in different densities at different locations and may have different neighboring circumferential spacings. As shown, there can be a larger number of the elongate rods 15 per unit area at a center “C” of the lens 10 than at the outer perimeter/diameter thereof.

Referring to FIGS. 1-3, the elongate rod 15 can have a diameter “a” that is much less than a longitudinal length “L” of the elongate rod 15. In some embodiments, the length “L” of the elongated rod 15 corresponds to at least a wavelength, typically 150 mm to 2000 mm, whereas the diameter “a” is preferably ¼ wavelength or less of the wavelength of the operating frequency. In some embodiments, this can equate to a diameter of about 5 mm to about 30 mm. In some embodiments, the length “L” of the elongate rod 15 is at least 10 time greater, typically 50-200 times greater, than the diameter “a”. The “wavelength” reference refers to an operating wavelength of one or more radiating elements in front of the lens. The term “operating wavelength” refers to the wavelength corresponding to the center frequency of the operating frequency band of the radiating element(s), e.g., low band radiating elements.

The elongate rods 15 can be provided in a length in a range of 1-2 meters in some particular embodiments. The elongate rods 15 can be provided in a diameter or diameters in a range of 5-50 mm in example embodiments, dependent on the frequency of operation.

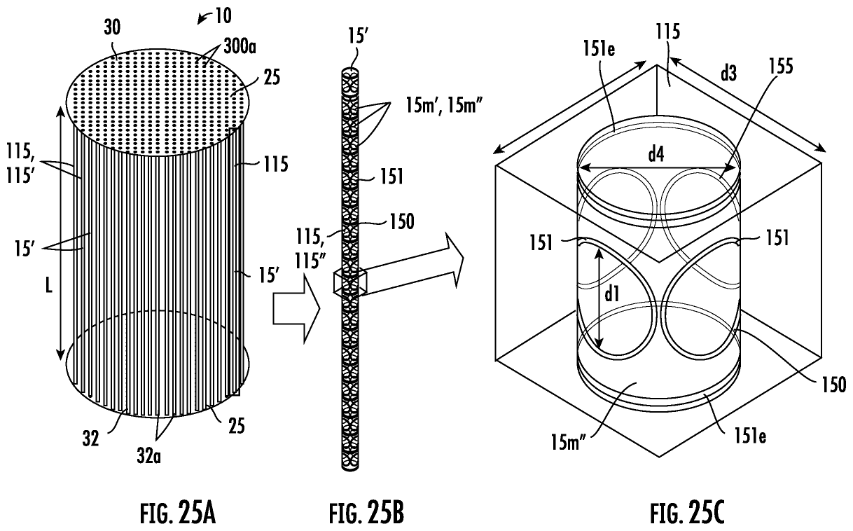

The elongate rods 15 can extend longitudinally substantially an entire length of the lens 10 (FIGS. 24A, 25A). The term “substantially” for this length means within +/−20% of the length of the lens 10.

The elongate rods 15 may be formed as a monolithic unitary dielectric member. Alternatively, the elongate rods 15 can be formed using a series of stackable rod members 15m (FIGS. 1, 7, 24A, 25A). The stackable rod members 15m can be provided in the same lengths or different lengths to provide a respective elongate rod 15. The stackable rod members 15m can have a length in a range of 5 mm to 30 mm, in some particular embodiments.

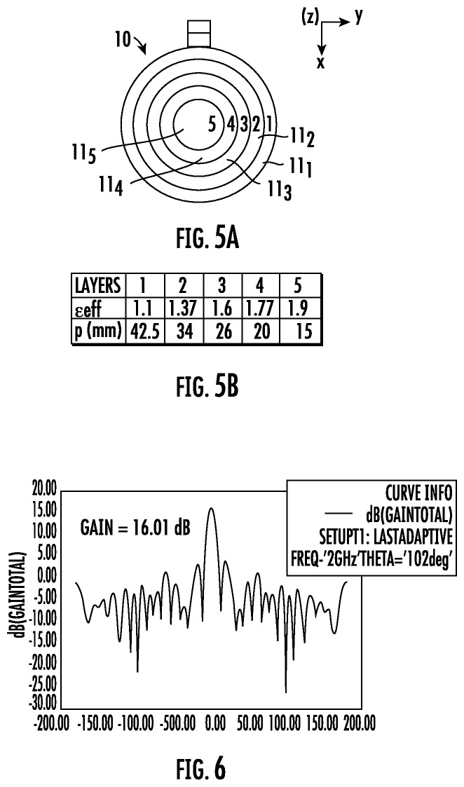

FIGS. 5A and 5B show that, in some embodiments, the RF lens 10 can have at least five different layers/regions 11, in the X-Y plane as shown, and shown as 11₁, 11₂, 11₃, 11₄, 11₅, with each layer/region 11 defining a different effective permittivity ε_{eff} and configured with the greatest effective permittivity at a center region (11₅) and with decreasing effective permittivities radially outward from the center region. The center region 11₅ can be circular and a plurality of the layers/regions 11 radially outward therefrom can be annular, with at least a first annular region of elongate rods 15 surrounding another annular region of elongate rods 15.

A respective elongate rod 15 can have a permittivity ε defined by its diameter and material.

As shown in FIG. 3, the effective permittivity 249 _{eff} of a respective region/layer 11 is based on the permittivity ε of the elongate rods 15 present in the region/layer in combination with the surrounding environment/material such as air and/or a dielectric material. The permittivity ε of the elongate rod 15 can be in a range of 2.2 to 10.2, shown as 3.66. The diameter of the elongate rod 15 can be any suitable diameter less than ¼ wavelength with respect to rod permittivity, typically in a range of 5 mm to 30 mm, shown as 11.5 mm.

FIGS. 4 and 6 illustrates the simulated performance of the lens. FIG. 6 shows a peak gain of 16.01 dB at 0 degrees/phase (azimuth angle) and illustrating that directive properties are similar to conventional/true Luneberg lens even without optimization.

In the embodiment shown in FIGS. 1 and 2, the different effective permittivities can be provided by different circumferential spacings “p” between neighboring rods 15 in a respective ring at different regions. However, the different effective permittivities can be provided by using different diameter rods 15, different materials for the rods 15 and/or different spacings “p”. The center region 115 has the largest effective permittivity ε_{eff} and the effective permittivity can decrease as the rods 15 approach the outer diameter of the lens body 10b. The spacing “p” can be defined as the spacing between the longitudinal axes of two immediately adjacent (neighboring) rods 15, which may vary in respective regions 11.

The number of different regions/layers 11 can vary but is typically in a range of 4-25 to closely approximate a true/ideal Luneberg lens. Th side-lobe-levels can depend on the number of layers.

In generally, increasing the lens diameter, the beamwidth will narrow. The number of layers will define the side lobe level. After 5 layers, the side lobe may become consistent so that 3-5 layers may be advantageous for most beamwidth ranges, whether the lens is smaller or larger. For a four-beam multiple-beam antenna with azimuth HPBW of 18 degrees, at least 3 layers/regions 11 of different effective permittivity ε_{eff} are preferred.

For smaller diameter lens' 10 and/or for antennas that have a single or dual beam configuration, the number of different regions/layers 11 may be less important than applications using larger diameter lens and 1-3 regions 11 may be used in such smaller diameter lens 10.

Other lens' 10, 4-25 or even more different regions/layers 11, may be used, particularly when used for antennas configured to generate 3 or more antenna beams.

FIG. 2 shows the elongate rods 15 in five different regions 20₁, 20₂, 20₃, 20₄, 20₅ of elongate rods 15, each with at least one ring 20r of elongate rods 15. There can be a decreasing density of the elongate rods 15 in the different regions, from a center C to the outer diameter of the lens 10. The inner or first region 201 can have a center rod 15 and a first plurality of rings 20r of the elongate rods 15 surrounding the center rod 15c. The second region 20₂ can have a second plurality of rings 20r of the elongate rods 15 surrounding the first region 20₁. The third region 20₃ can have a third plurality of rings 20r of elongate rods 15 surrounding the second plurality of rings 20₂. The fourth region 20₄ can have at least one ring 20r surrounding the third region 20₃. The fifth region 20₅ can have at least one ring 20r surrounding the fourth region 20₄.

Still referring to FIG. 2, an outer ring 20r of the elongate rods 15 can have a circumferential spacing “p₁” between neighboring rods while a first ring 20r more inward can have a circumferential spacing that is p₂, where p₁>p₂. The spacing “p” between circumferentially adjacent elongate rods 15 can decrease as the elongate rods 15 are positioned closer to the center C of the lens body 10b. As shown, a second ring 20r that is closer to the center C than the first ring 20r can have a spacing p₃, where p₂>p₃.

At least some of the rings 20r can be concentric rings of the elongate rods 15.

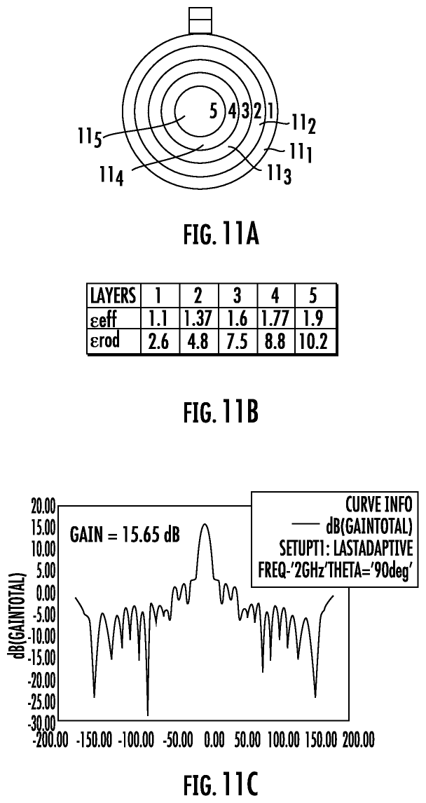

FIGS. 7 and 8 illustrate another embodiment of the lens 10′ with the elongate rods 15. In this embodiment, shown with the same number of layers/regions 11 as FIGS. 1 and 2, most or all of the elongate rods 15 can have substantially equal spacing (recognizing some variation may occur in manufacturing tolerances, such as 1-2 mm variation) in at least some of the layers/regions 11 and the elongate rods 15 can be provided with different permittivity materials defining different effective permittivities in the different regions/layers 11 (FIGS. 11A, 11B).

FIG. 11A shows five layers/regions 11 extending in the X-Y plane. FIG. 11B shows five different permittivity ε values, one for each layer region 11₁-11₅, with the greatest ε value at the center region 11₅. The elongate rods 15 may be provided with a common outer diameter “a” as shown in FIGS. 8 and 9. As per the first embodiment discussed above, the effective permittivity ε_{eff} is defined based on the ε of the elongate rod 15 and its surrounding environment.

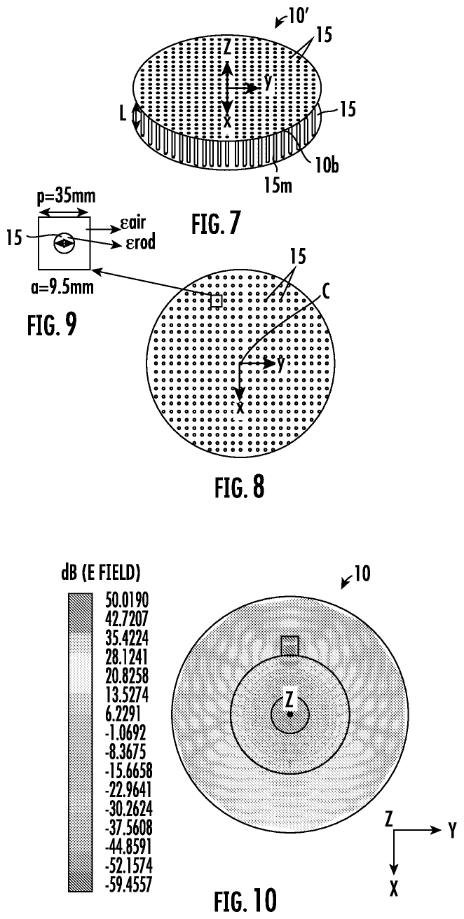

FIGS. 10 and 11C illustrate a simulated lens performance. FIG. 11C shows peak gain of 15.65 dB at 0 degrees/scanning angle and illustrating that directive properties are similar to conventional/true Luneberg lens even without optimization.

The elongate rods 15 can be provided as homogeneous dielectric cylindrical rod 15 with stackable rod members 15m. The elongate rods 15 can have a hollow interior or lumen.

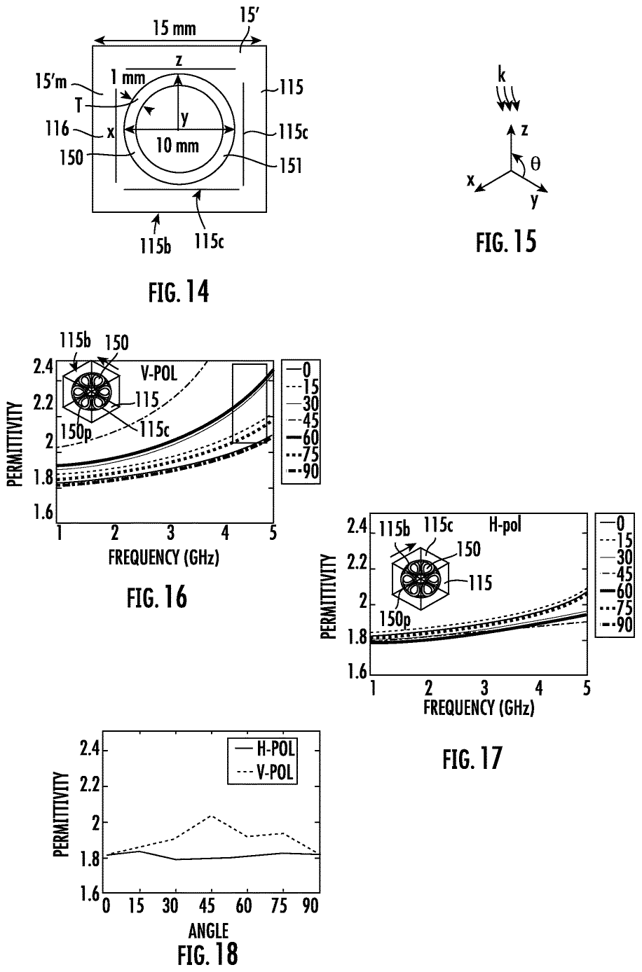

The stackable rod members 15m for the elongated rods 15 can be configured to provide the same permittivity as a homogeneous dielectric cylinder rod. The stackable rod members 15m forming respective elongate rods 15 can have a hollow interior or a solid core. Combinations of different types of hollow and solid rod members can be used. Combinations of elongate rods 15 having respective homogenous dielectric bodies with elongate rods 15 comprising unit cells of meta material forming stackable members 15m′ (FIGS. 13-22) can also be used to form a respective lens 10 in some embodiments.

One or more of the elongate rods 15 can have a solid, heterogenous dielectric body formed of a continuous body without requiring stackable members 15.

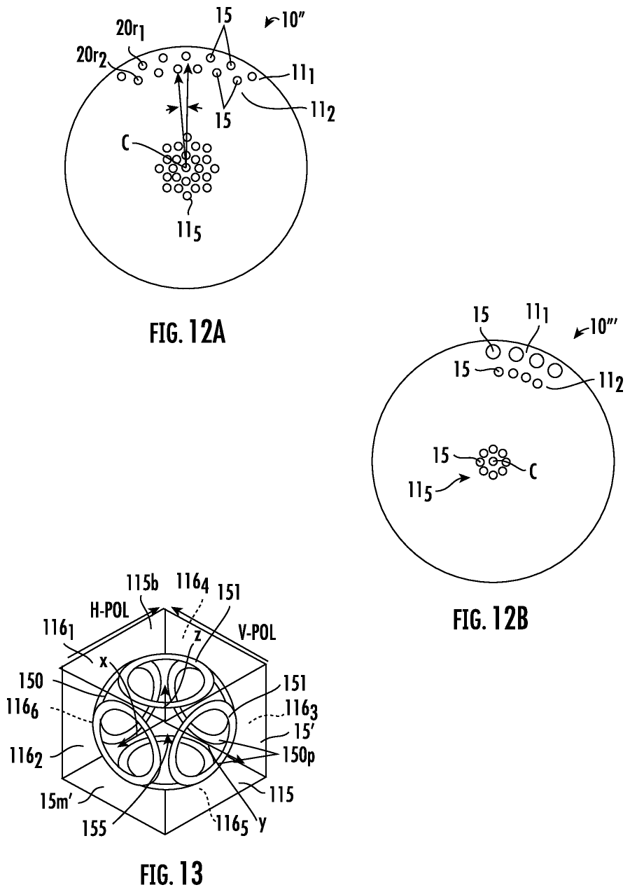

In the embodiment shown in FIGS. 1 and 2, rings 20r can provide the respective elongate rods 15 to be substantially radially aligned from a center to an outer diameter of the lens. FIG. 12A is a schematic illustration of a portion of another embodiment of a lens 10″ (illustrating only some of the elongate rods 15) to show the lens 10″ can be configured so that at least some adjacent rows 20r₁, 20r₂ position respective elongate rods 15 that are circumferentially offset and which may provide a more uniform dielectric constant within each region and/or which may facilitate permittivity, hence effect the directivity. The elongate rods 15 can have the same or different diameters, materials and the like forming the same or different permittivity ε.

FIG. 12B is a schematic illustration of a portion of the lens 10″′ (illustrating only some of the elongate rods 15) showing that the lens 10″′ can be configured to have different diameters of the elongate rods 15 in different regions 11₁, 11₂, 11₅ with the same or different permittivy ε.

Turning now to FIGS. 13-18, a unit cell structure 115 comprising a meta-material 150 arranged in a pattern is shown. The unit cell structure 115 with the meta-material 150 can be configured to be isotropic and the RF energy for the antenna beam can propagate in the Z-direction (FIG. 15) with an angle or incidence about the X-axis. The unit cell structure 115 can have at least one ring 151 on each primary surface 115 or “face”, shown as six primary surfaces 116₁-116₆, with six rings 151 in six directions forming a cubic ring structure. The (cubic) unit cell structure 115 can be configured to provide a perfect electrical conductor (PEC) in six directions. The unit cell structure 115 can be isotropic in three dimensions. The unit cell structure 115 can have a center space 155 that can comprise a low dielectric material, such as air, for example.

The meta-material 150 can have a pattern 150p that can be provided on or in a substrate 115b of the unit cell structure 115. The substrate body can be a cube inner body 115c that can be held in/be encapsulated by another outer substrate body 115b that can be rectangular or square but may have other shapes. The outer substrate body 115b can be formed of a dielectric light weight material, such as a foamed dielectric material, such as, but not limited to, Roger-5880 (PTFE), thickness of about 5 mils.

The unit cell structure 115 (outer box) can comprise meta-material forming a segment of a cylindrical rod 15 and ½ the immediate air volume between it and the next cylinder rod 15 in each direction. The permittivity range of the unit cell 115 can be in a range of 1-2. The permittivity range of just the metamaterial-based cylinder is 2.2 to 10.2.

The unit cell 115 (outer box) comprises the cubic structure with metamaterial pattern 150p and ½ the immediate air volume between it and the next cubic in each direction. The range of the outer box can be in a range of 10 mm to 35 mm. The range of cubic structure with the meta-material pattern 150p can be in a range of 5 mm to 30 mm.

The inner body 115c can have an open or low-loss material center inside the three-dimensional meta-material pattern 150p. The term “low-loss” refers to a material's inherent dissipation of electromagnetic energy often referred to as “tangent loss”. The smaller the tangent loss, the less lossy the material. For example, Roger-5880 has a tangent loss of 0.0009 whereas FR4 material has a tangent loss of 0.021. Therefore Roger-5880 is a low loss material compared to FR4. Typically, “low-loss” materials have a tangent loss that is less than 0.001.

FIG. 16 shows simulated permittivity (of the unit cell structure of FIG. 13) versus frequency (GHz) as a function of the azimuth scanning angle of the antenna beam for vertical polarization “V-pol”. FIG. 17 shows simulated permittivity versus frequency (GHz) as a function of the azimuth scanning angle of the antenna beam for horizontal polarization “H-pol”. FIG. 18 shows simulated permittivity versus azimuth scanning angle for H-pol and V-pol.

The unit cell structure 115 can form part of the lens 10, 10′ and/or part of the elongate rod 15′. The unit cell structure 115 can be configured as a stackable rod member 15m′ of the lens 10, 10′ (FIG. 25A).

The meta-material pattern 150p providing the rings 151 can be printed, deposited, sprayed, lithographed or otherwise formed onto a three-dimensional substrate body. The meta-material pattern 150p can be printed, deposited, sprayed, lithographed or otherwise formed on a two-dimensional substrate that can then be formed into a three-dimensional unit cell structure 115, in some embodiments.

The rings 151 can be configured as open or closed loops or other suitable shapes. To be clear, the term “rings” with respect to the meta-material shape does not require a circular closed configuration. The ring 151 can have loop segments that can be capacitively coupled or closed rather than a continuous closed path. The meta-material rings 151 can have a thickness T in an X-Y plane that is in a range of 1-20% of a diameter thereof. The thickness T can be less than 1 mm and may be provided in a range of 15-50 micrometers, typically 17.5 to 35 micrometers, in particular embodiments. The diameter of the ring 151 can be less than ¼ wavelength of the operational frequency, which can be typically in a range of 1 mm to 25 mm, such as about 10 mm.

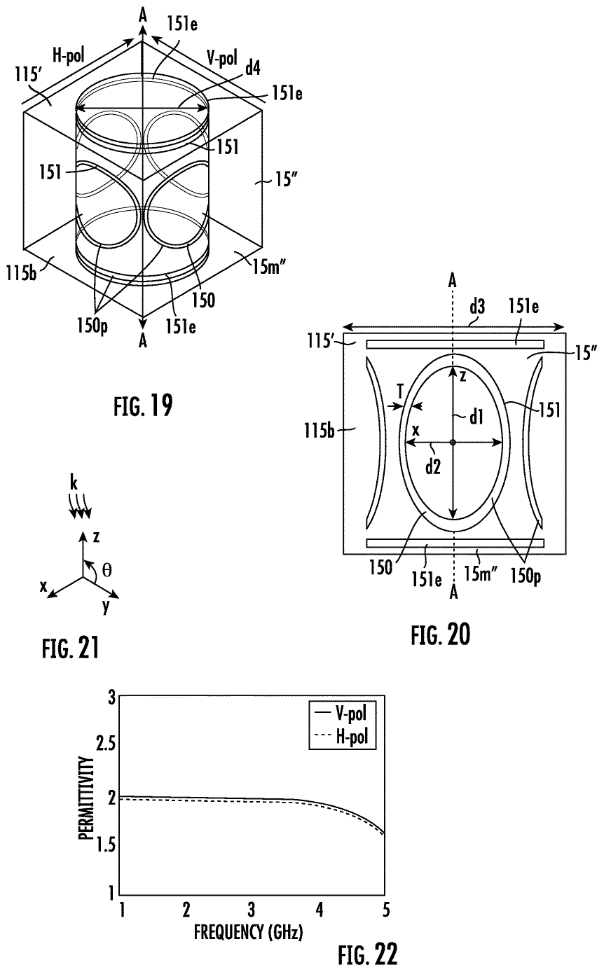

Another embodiment of a unit cell structure 115′ comprising the meta-material 150 is shown with reference to FIGS. 19-22. The unit cell structure 115′ can be arranged to provide a cylindrical meta-material structure having an axially extending center line A-A and comprising a plurality of rings 151. The meta-material pattern 150p can provide rings 151 that can have a major diameter d1 and a minor diameter d2 and may have an oval shape. The cylinder unit cell structure 115′ can have a diameter d3 and d3>d1, typically 20%-50% greater. The meta-material end rings 151e can have a diameter d4, d4>d1, typically 10-30% greater.

In the orientation shown, the minor diameter d2 is along an X-Y plane and is oriented with an angle of incidence about the X-axis with the RF energy forming the antenna beam propagating in the Z-axis direction (FIG. 21) and oriented with the axially extending center line A-A in line with the Z axis. The unit cell structure 115′ can comprise four rings 151 that are spaced apart about the cylindrical structure which may reside between two opposing end rings 151e. The cylindrical unit cell structure 115′ can be provided in a substrate body 115b which may be rectangular or have other shapes. As before, the unit cell structure 115′ can form a stackable rod member 15m″ for an elongate rod 15″ of a lens 10, 10′ (FIG. 25A).

FIG. 22 shows simulated permittivity versus frequency (GHz) for V-pol and H-pol for the embodiment shown in FIGS. 19 and 20.

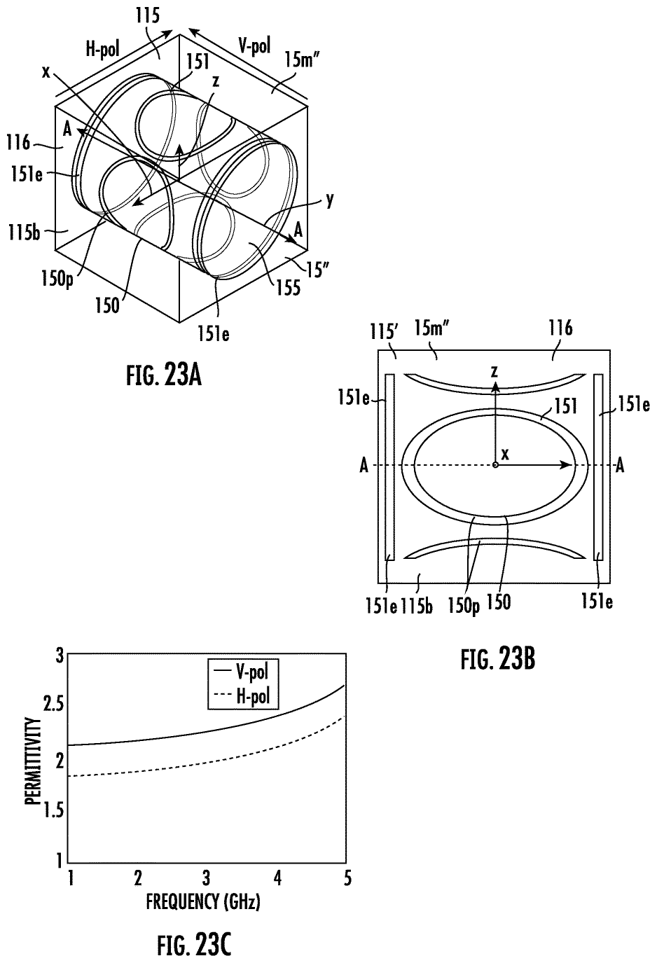

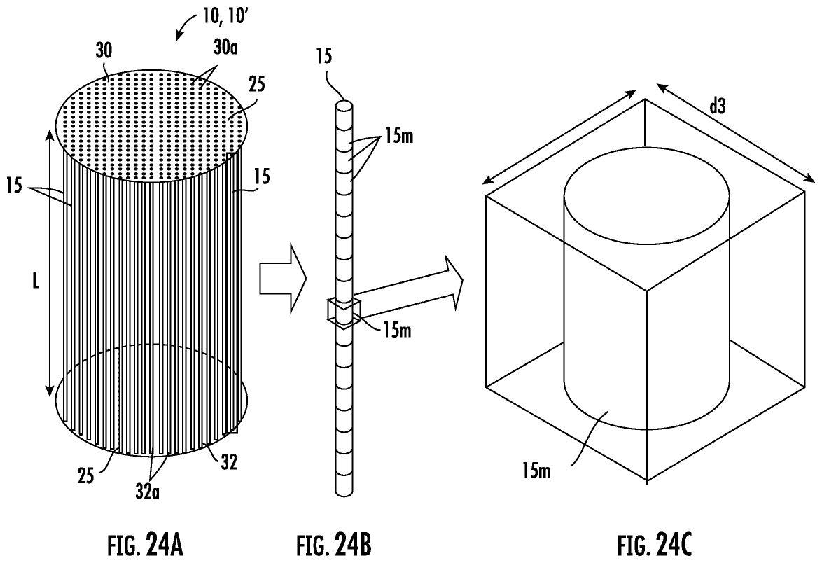

FIGS. 23A and 23B show the unit cell structure 115′ of FIGS. 19 and 20 in a different orientation with the axial extending center line A-A of the cylindrical body oriented perpendicular to the Z-axis (FIG. 21).

FIG. 23C shows a simulated permittivity versus frequency (GHz) V-pol and H-pol for the orientation in FIGS. 23A, 23B.

FIG. 24A illustrates a lens 10, 10′ formed of a plurality of elongate rods 15. FIG. 24B illustrates an example elongate rod 15 formed of stackable rod members 15m. FIG. 24C illustrates one of the stackable members 15m and surrounding space forming an effective permittivity as discussed above. The number of stackable members 15m used to form a respective elongate rod 15 can be in a number sufficient to have a length in a range of 1 meter to 2 meters, in some embodiments. The elongate rods 15 can be provided in an isotropic distribution. The lens 10, 10′ can have upper and lower end caps 30, 32 and each can have apertures 30a, 32a that can receive and hold a portion of the elongate rod 15.

FIG. 25A illustrates a lens 10, 10′ formed of a plurality of elongate rods 15′. The lens 10, 10′ can have upper and lower end caps 30, 32 and each can have apertures 30a, 32a that can receive and hold a portion of the elongate rod 15′.

FIG. 25B illustrates an example elongate rod 15′ formed of the stackable rod members 15m′, 15m″ comprising unit cell structures 115, 115′ comprising meta-material 150. FIG. 25C illustrates one of the stackable members 15m″ with the (cylindrical) unit cell structure 115′ comprising a plurality of rings 151 of meta-material 150 (shown as four circumferentially spaced apart rings on a cylindrical surface and with optional two end rings about 151e on opposing ends). The number of stackable members 15m′ or 15m″ used to form a respective elongate rod 15′ can be in a number sufficient to have a length in a range of 1 meter to 2 meters, in some embodiments.

The number of elongate rods 15, 15′ can be 100-10,000, more typically 100-1000, depending on the overall lens size, number of layers and configuration of respective rods 15, 15′ forming the lens 10. The number of stacked rod members 15m, 15m′ forming respective rods 15, 15′ can be in a range of 10-100, more typically 50-100 for a cylindrical lens (L=2 meter) shape at 2 GHz, particularly where the stackable members 15m′ comprise the meta-material unit cells.

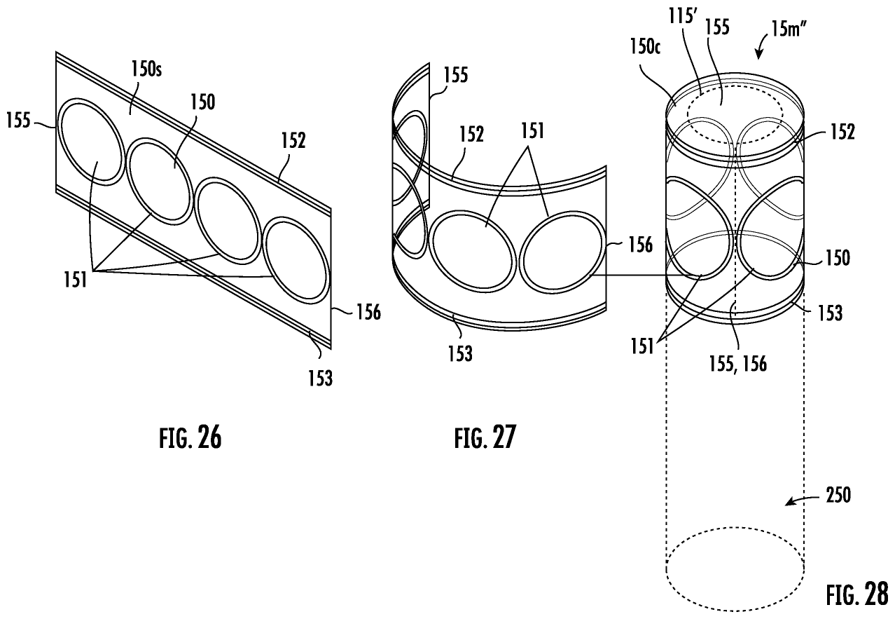

FIGS. 26-28 show a rollable substrate 150s comprising the meta-material pattern 150p with the rings 151. The rollable substrate 150s can be a polyester film. The meta-material pattern 150p can be printed or sprayed (using a template, for example) thereon, similar to a flex printed circuit board. Straight lines of meta-material 152, 153 can extend on upper and lower ends (in the orientation shown) and the substrate 150s can be rolled to form a cylindrical body 150c with the free ends 155, 156 then rolled to be closed together or positioned adjacent each other, such as one over the other, abutting each other or closely spaced apart from each other. The straight lines 152, 153, when rolled, form the end rings 151e. In the rolled configuration providing the cylindrical body, free ends of the rollable substrate are electrically decoupled.

The rollable substrate 150s can be applied to an outer surface of a long, (cylindrical) straw, such as for example, a low-loss straw, providing a respective light weight rod 15′ or stackable rod members 15m″. The straw 250 (FIG. 28) may have a continuous outer surface of may comprise a series of open through apertures. The straw can be provided as a low-loss, low-weight material such as Rohacell foam.

Referring to FIG. 29, another embodiment of a unit cell structure 115″′ is shown. In this embodiment, the unit cell structure 115″ has a pyramid shape with four primary surfaces 116 with one of the four rings 151 of meta-material 150 in one of the four different corresponding directions of the four primary faces 116.

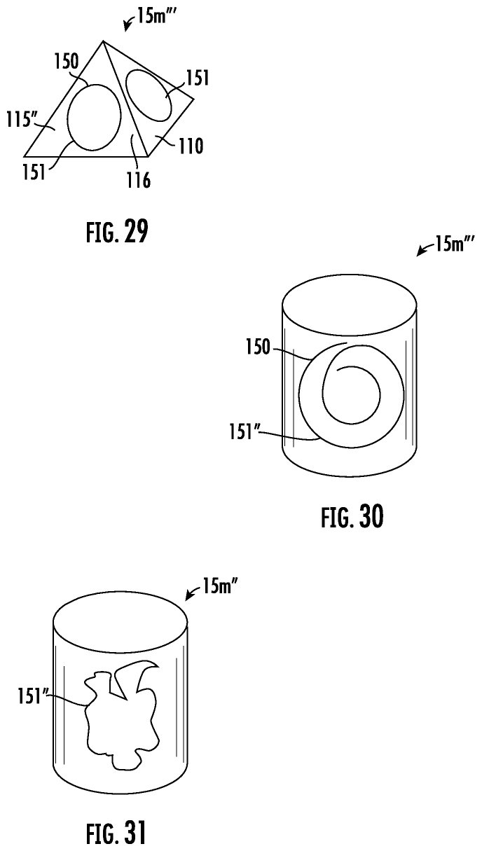

Referring to FIGS. 30, 31, the rings 151″ can be provided in a configuration that meanders with a curvilinear perimeter (FIG. 30) or FIG. 8 pattern (FIG. 31), for example. The length of the line forming the meandering perimeter can be configured to match d1, d3 or d4 discussed above.

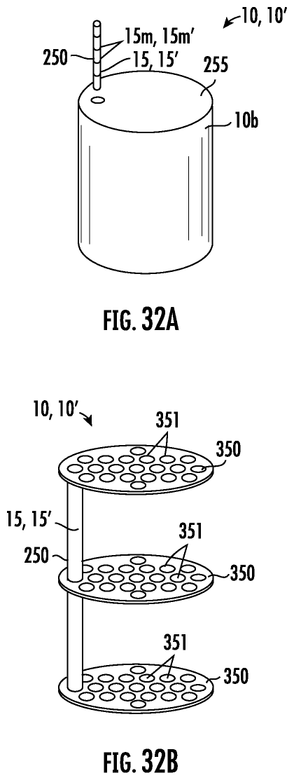

FIG. 32A illustrates that the elongate rods 15, 15′ can be inserted into a core material 255 of the lens body 10b to form the lens 10, 10′. The core material 255 can be a foamed composite or polymer or other low-loss, light weight material. A straw 250, such as a dielectric straw of any suitable material including, for example, a polymer, copolymer and/or low-loss plastic straw can be used to hold the stackable rod members 15m, 15m′ in alignment and to insert them together into the core material 255. The straw 250 can be inserted into the core material 255 prior to or after placing the rod members 15m, 15m′ therein. As discussed above, the straw 255 may have closed outer surface or may comprise a plurality of apertures sized to maintain the stackable members 15m, 15m′ therein. In some embodiments, the straws can be omitted and the elongate rods 15, 15′ can be inserted directly into the lens body 10b or into respective cylindrical openings provided by the lens body 10b.

FIG. 32B illustrates, in other embodiments, a plurality of cooperating light weight dielectric spacers 350 with a pattern of apertures 351 can be used to hold the elongate rods 15, 15′ in desired positions to form the lens 10, 10′. Again, a straw 250 can be used to hold the stackable rod members 15m, 15m′ in alignment. The straw 250 can be inserted into the spacers 350 prior to or after placing the rod members 15m, 15m′ therein.

The density of the dielectric material forming the elongate rods 15 can be, for example, between 0,005 to 0.2 g/cm³, in some embodiments.

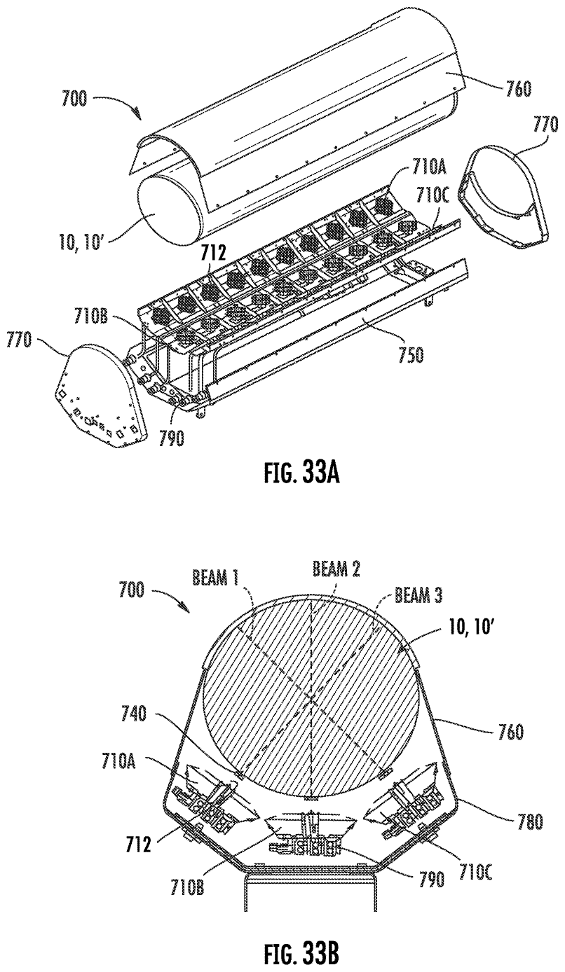

FIG. 33A is a perspective view of a lensed base station antenna 700 according to embodiments of the present invention. FIG. 33B is a cross-sectional view of the lensed base station antenna 700. The lensed base station antenna 700 is a multi-beam antenna that generates three separate antenna beams through a single RF lens 10, 10′.

Referring to FIGS. 33A and 33B, the multi-beam base station antenna 700 includes one or more linear arrays of radiating elements 710A, 710B, and 710C (which are referred to herein collectively using reference numeral 710). The antenna 700 further includes the RF lens 10, 10′. In some embodiments, each linear array 710 may have approximately the same length as the lens 10, 10′, The multi-beam base station antenna 700 may also include one or more of a reflector 750, a radome 760, end caps 770, a tray 780, and input/output ports 790. In the description that follows, the azimuth plane is perpendicular to the longitudinal axis of the RF lens 10, 10′, and the elevation plane is parallel to the longitudinal axis of the RF lens 10, 109.

The RF lens 10, 10′ is used to focus the radiation coverage pattern or “beam” of the linear arrays 710 in the azimuth direction. For example, the RF lens 730 may shrink the 3 dB beam widths of the beams (labeled BEAM1, BEAM2 and BEAM3 in FIG. 33B) output by each linear array 710 from about 65° to about 23° in the azimuth plane. While the antenna 700 includes three linear arrays 710, it will be appreciated that different numbers of linear arrays 710 may be used.

Each linear array 710 includes a plurality of radiating elements 712. Each radiating element 712 may comprise, for example, a dipole, a patch or any other appropriate radiating element. Each radiating element 712 may be implemented as a pair of cross-polarized radiating elements, where one radiating element of the pair radiates RF energy with a +45° polarization and the other radiating element of the pair radiates RF energy with a −45° polarization.

The RF lens 10, 10′ can be configured to narrow the half power beam width (“HPBW”) of each of the linear arrays 710 while increasing the gain of the beam by, for example, about 4-5 dB for the 3-beam multi-beam antenna 700 depicted in FIGS. 33A and 33B. All three linear arrays 710 share the same RF lens 10, 10′, and thus each linear array 710 has its HPBW altered in the same manner. The longitudinal axes of the linear arrays 710 of radiating elements 712 can be parallel with the longitudinal axis of the lens 730. In other embodiments, the axis of the linear arrays 710 can be slightly tilted (2-10°) to the axis of the lens 10, 10′ (for example, for better return loss or port-to-port isolation tuning).

The multi-beam base station antenna 700 as described above may be used to increase system capacity. For example, a conventional 65° azimuth HPBW antenna could be replaced with the multi-beam base station antenna 700 as described above. This would increase the traffic handling capacity for the base station, as each beam would have 4-5 dB higher gain and hence could support higher data rates at the same quality of service. In another example, the multi-beam base station antenna 700 may be employed to reduce antenna count at a tower or other mounting location. The three beams (BEAM 1, BEAM 2, BEAM 3) generated by the antenna 700 are shown schematically in FIG. 33B. The azimuth angle for each beam may be approximately perpendicular to the reflector 750 for each of the linear arrays 710. In the depicted embodiment the −10 dB beamwidth for each of the three beams is approximately 40° and the center of each beam is pointed at azimuth angles of −40°, 0°, and 40°, respectively. Thus, the three beams together provide 120° coverage.

In some embodiments, the RF lens 10, 10′ may have a circular cylinder shape. In other embodiments, the RF lens 10, 10′ may comprise an elliptical cylinder shape, which may provide additional performance improvements (for example, reduction of the sidelobes of the central beam). Other shapes may also be used.

It will be appreciated that any appropriate radiating elements 712 may be used. For example, in other embodiments, the linear arrays 710 may include box radiating elements that are configured to radiate in different frequency bands, interleaved with each other as shown in U.S. Pat. No. 7,405,710, which is incorporated herein by reference. In these linear arrays, a first array of box-type dipole radiating elements is coaxially disposed within a second box-type dipole assembly and located in one line. This allows a lensed antenna to operate in two frequency bands (for example, 0.79-0.96 and 1.7-2.7 GHz). For the antenna to provide similar beam widths in both frequency bands, the high band radiating elements should have directors. In this case, a low band radiating element may have, for example, a HPBW of 65-50°, and a high band radiating element may have a HPBW of 45-35°, and in the result, the lensed antenna will have stable HPBW of about 23° (and beam width about 40° by −10 dB level) across both frequency bands.

As is further shown in FIG. 33B, the multi-beam base station antenna 700 may also include one or more secondary lenses 740. A secondary lens 740 can be placed between each linear array 710A, 710B, and 710C and the RF lens 10, 10′. The secondary lenses 740 may facilitate azimuth beamwidth stabilization. The secondary lenses 740 may be formed of dielectric materials and may be shaped as, for example, rods, cylinders or cubes. Other shapes may also be used.

The use of a cylindrical lens such as lens 10, 10′ may reduce grating lobes (and other far sidelobes) in the elevation plane. This reduction is due to the lens 730 focusing the main beam only and defocusing the far sidelobes. This allows increasing spacing between the antenna elements 712. In non-lensed antennas, the spacing between radiating elements in the array may be selected to control grating lobes using the criterion that dₘₐₓ/λ<1/(sinθ₀+1), where dₘₐₓ is maximum allowed spacing, λ is the wavelength and θ₀ is scan angle. In the lensed antenna 700, spacing dₘₐₓ can be increased: dₘₐₓ/λ=1.2^{~}1.3[1/(sin θ₀+1)]. So, the lens 10, 10′ allows the spacing between radiating elements 712 to be increased for the multi-beam base station antenna 700 while reducing the number of radiating elements by 20-30%. This results in additional cost advantages for the multi-beam base station antenna 700.

Referring again to FIGS. 33A and 33B, the radome 760, end caps 770 and tray 780 protect the antenna 700. The radome 760 and tray 780 may be formed of, for example, extruded plastic, and may be multiple parts or implemented as a single piece. In other embodiments, the tray 780 may be made from metal and may act as an additional reflector to improve the front-to-back ratio for the antenna 700. In some embodiments, an RF absorber (not shown) can be placed between the tray 780 and the linear arrays 710 for additional back lobe performance improvement. The lens 10, 10′ is spaced such that the apertures of the linear arrays 710 point at a center axis of the lens 730.

The antenna 700 of FIGS. 33A-33B has an RF lens 10, 10′ that has a flat top and a flat bottom, which may be convenient for manufacturing and/or assembly. However, it will be appreciated that in other embodiments an RF lens may be used instead that has rounded (hemispherical) ends. The hemispherical end portions may provide additional focusing in the elevation plane for the radiating elements 712 at the respective ends of the linear arrays 710. This may improve the overall gain of the antenna.

It will likewise be appreciated that the lenses according to embodiments of the present invention may be used in dual and/or multiband base station antennas. Such antennas may include, for example antennas providing ports for transmission and reception in the 698-960 MHz frequency band as well as in the 1.7-2.7 GHz frequency band or, as another example, in both the 1.7-2.7 GHz frequency band and the 3.4-3.8 GHz frequency band. A homogeneous cylindrical RF lens works well when its diameter D=1.5-6λ (where λ is the wavelength in free space of the center frequency of the transmitted signal). Consequently, such lenses may be used with respect to the above example frequency bands as the diameter of the lens may be selected so that the lens will perform well with respect to both frequency bands. In order to provide the same azimuth beamwidth for both bands (if desired in a particular application), the azimuth beam width of the low band linear array (before passing through the RF lens) may be made to be wider than the azimuth beam width of the high band linear array, approximately in proportion to a ratio of the center frequencies of the two bands.

It will also be appreciated that the amount that an RF lens shrinks the beamwidth of an antenna beam that passes therethrough varies with the frequency of the signals being transmitted and received by the antenna. In particular, the larger the number of wavelengths that an RF signal cycles through in passing through the lens, the more focusing that will occur with respect to the antenna beam. For example, a particular RF lens will shrink a 2.7 GHz beam more than a 1.7 GHz beam.

There are a number of antenna applications in which signals in multiple different frequency ranges are transmitted through the same antenna. One common example is multi-band base station antennas for cellular communications systems. Different types of cellular service are supported in different frequency bands, such as, for example, GSM service which uses the 900 MHz (namely 990-960 MHz) and 1800 MHz (namely 1710-1880 MHz) frequency bands, UTMS service which uses the 1920-2170 MHz frequency band, and LTE service which uses the 2.5-2.7 GHz frequency band. A single base station antenna may have multiple arrays of different types of radiating elements that support two or more different types of cellular service and/or may have wideband radiating elements that transmit and receive signals for multiple different types of service.

When an RF lens is used with such antennas (and where it is not possible or practical to use different RF lenses for different types of radiating elements), a Luneburg lens may be used to partially offset the effect that the difference in frequency has on the beamwidth of the antenna beams for the different frequency bands. However, in some cases, even when a Luneburg lens is used, the beam for the high frequency band may be more tightly focused than the beam for the lower frequency band. This may cause difficulties, since RF planners often want the coverage areas to be the same for each frequency band, or at least for all frequencies that are serviced by a particular column of radiating elements.

Pursuant to further embodiments of the present invention, antennas are provided that have radiating elements that have a beamwidth that increases with frequency which can be used to offset the narrowing effect that an RF lens may have on beamwidth as a function of frequency.

In light of the above, it will be appreciated that the antennas according to embodiments of the present invention may be multiband antennas that include multiple columns of different types/sizes of radiating elements that are designed to transmit/receive signals in different frequency bands and/or antennas that have wideband radiating elements that are designed to transmit and receive signals in multiple different frequency bands. In some embodiments, these antennas may include radiating elements that are designed to have a beamwidth that varies as a function of frequency in the manner described above. In some embodiments, this variation may be relatively linear across the frequency bands of interest. These antennas according to embodiments of the present invention may use any of the RF lenses described herein.

In some embodiments, each radiating element 912 may be angled with respect to the second vertical axis. In particular, each radiating element 912 may be mechanically angled downwardly or “downtilted” with respect to the second vertical axis. For example, each radiating element 912 may be mechanically angled downward from the horizontal by 5 degrees. Additionally, each radiating element 912 may be arranged orbitally with respect to its associated RF lens 10, 10′ (i.e., pointed toward the center of the spherical RF lens).

While the description above has primarily focused on using RF lenses with base station antennas in cellular communications systems, it will readily be appreciated that the RF lenses disclosed herein and/or the unit cell structures with the meta-material may be used in a wide variety of other antenna applications, specifically including any antenna applications that use a phased array antenna, a multi-beam antenna or a reflector antenna such as parabolic dish antennas. By way of example, backhaul communications systems for both cellular networks and the traditional public service telephone network use point-to-point microwave antennas to carry high volumes of backhaul traffic. These point-to-point systems typically use relatively large parabolic dish antennas (e.g., parabolic dishes having diameters in the range of, perhaps, one to six feet), and may communicate with similar antennas over links of less than a mile to tens of miles in length. By providing more focused antenna beams, the sizes of the parabolic dishes may be reduced, with attendant decreases in cost and antenna tower loading, and/or the gain of the antennas may be increased, thereby increasing link throughput. Thus, it will be appreciated that embodiments of the present invention extend well beyond base station antennas and that the RF lenses disclosed herein can be used with any suitable antenna.

While the foregoing examples are described with respect to one beam and three beam antennas, additional embodiments including, for example, antennas having 2, 4, 5, 6 or more beams are also contemplated. It will also be appreciated that the lens may be used narrow at least the azimuth beam of a base station antenna from a first value to a second value. The first value may comprise, for example, about 90°, 65° or a wide variety of other azimuth beamwidths. The second value may comprise about 65°, 45°, 33°, 25°, etc. It will also be appreciated that in multi-band antennas according to embodiments of the present invention the degree of narrowing can be the same or different for the linear arrays of different frequency bands.

Embodiments of the present invention have been described above with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “on” another element, it can be directly on the other element or intervening elements may also be present. In contrast, when an element is referred to as being “directly on” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between”, “adjacent” versus “directly adjacent”, etc.).

Relative terms such as “below” or “above” or “upper” or “lower” or “horizontal” or “vertical” may be used herein to describe a relationship of one element, layer or region to another element, layer or region as illustrated in the figures. It will be understood that these terms are intended to encompass different orientations of the device in addition to the orientation depicted in the figures.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, operations, elements, and/or components, but do not preclude the presence or addition of one or more other features, operations, elements, components, and/or groups thereof.

Aspects and elements of all of the embodiments disclosed above can be combined in any way and/or combination with aspects or elements of other embodiments to provide a plurality of additional embodiments.

1. A lensed antenna, comprising:
an array of radiating elements; and
a lens positioned to receive electromagnetic radiation from at least one of the radiating elements, wherein the lens comprises a plurality of elongate rods that are spaced apart and that extend longitudinally along at least a major portion of a length dimension of the lens and about at least a major portion of an X-Y plane of the lens with the X-Y plane being perpendicular to the length dimension, wherein the elongate rods are dielectric and/or comprise a plurality of unit cell structures, each unit cell structure comprising meta-material in a three-dimensional pattern.

2. The lensed antenna of claim 1, wherein the lens is cylindrical, and wherein at least some of the plurality of elongate rods are radially and circumferentially spaced apart across an entire diameter of the lens.

3. The lensed antenna of claim 1, wherein at least some of the plurality of elongate rods are arranged in a plurality of rings.

4. The lensed antenna of claim 3, wherein at least 70% of the elongate rods are arranged in the plurality of rings and extend between an axially extending center of the lens to an outer diameter thereof.

5. The lensed antenna of claim 1, wherein at least some of the elongate rods are formed by a plurality of respective rod members that are longitudinally stacked.

6. (canceled)

7. The lensed antenna of claim 1, wherein the elongate rods are provided as a first plurality of rings positioned at an inner region of the lens and having a first spacing between circumferentially neighboring elongate rods, wherein the first plurality of rings are surrounded by a second plurality of rings having a second spacing between circumferentially neighboring elongate rods, with the second spacing being greater than the first spacing, and wherein the second plurality of rings are surrounded by a third plurality of rings having a third spacing between circumferentially neighboring elongate rods, wherein the third spacing is greater than the second spacing.

8. (canceled)

9. The lensed antenna of claim 1, wherein a first plurality of the elongate rods have a first permittivity, wherein a second plurality of the elongate rods surround the first plurality of the elongate rods and have a second permittivity that is different than the first permittivity, and wherein the second plurality of the elongate rods are surrounded by a third plurality of the elongate rods that have a third permittivity that is different than the first and second permittivities thereby providing a change in effective permittivity across a diameter of the lens.

10-11. (canceled)

12. The lensed antenna of claim 1, wherein the elongate rods comprise the unit cell structures comprising the meta-material in the three-dimensional pattern.

13. The lensed antenna of claim 12, wherein the unit cell structures are provided as a stacked series of unit cell structures forming a respective elongate rod member.

14. The lensed antenna of claim 12, wherein the unit cell structures comprise a cubic meta-material structure with the three-dimensional meta-material pattern comprising six rings, each of the six rings on a different one of six primary surfaces of the cubic meta-material structure.

15. The lensed antenna of claim 12, wherein the meta-material in the three-dimensional pattern comprises a cylindrical wall comprising four circumferentially spaced apart rings.

16. The lensed antenna of claim 15, wherein the four circumferentially spaced apart rings are oval.

17. The lensed antenna of claim 12, wherein the unit cell structure comprises a dielectric material that encapsulates the three-dimensional meta-material pattern.

18. The lensed antenna of claim 12, wherein the unit cell structures are rectangular and have a low-loss center and a dielectric outer surface, with the three-dimensional meta-material pattern sandwiched therebetween.

19. The lensed antenna of claim 12, wherein the unit cell structures comprise a rollable substrate comprising two-dimensional meta-material pattern that is rolled to define a cylindrical body shape comprising three-dimensional meta-material pattern.

20. The lensed antenna of claim 19, wherein, in the rolled configuration providing the cylindrical body, free ends of the rollable substrate are electrically decoupled.

21. A method of manufacturing a lens for an antenna, comprising:
providing a plurality of elongate rods, wherein the rods comprise a dielectric material and/or unit cell structures comprising a three-dimensional pattern of meta-material;
arranging the elongate rods to extend longitudinally a length of a body of the lens and spaced apart across a diameter thereof; and
forming a cylindrical lens comprising the elongate rods.

22-27. (canceled)

28. The method of claim 21, wherein the elongate rods comprise the unit cell structures, and wherein the providing the elongate rods is carried out by forming at least some of the elongate rods by stacking a series of the unit cell structures to form a respective elongate rod.

29. The method of claim 28, wherein the three-dimensional meta-material pattern comprises six rings oriented on or in six different primary surfaces of a cubic structure.

30. The method of claim 28, wherein the three-dimensional pattern of meta-material comprise four circumferentially spaced apart rings.

31-33. (canceled)

34. The method of claim 28, wherein the unit cell structures are rectangular and have a low-loss material center and a dielectric outer surface, with the meta-material sandwiched therebetween.

35. The method of claim 22, wherein the elongate rods comprise the unit cell structures, the method further comprising forming the unit cell structures by rolling a film comprising a two-dimensional meta-material pattern into a cylindrical form to define the three-dimensional meta-material pattern.

36. The method of claim 35, wherein, in an unrolled state, the two-dimensional meta-material pattern comprises first and second spaced apart straight lines with a plurality of rings therebetween.

37. A unit cell structure, comprising:
a cubic structure comprising six primary surfaces; and
a meta-material pattern on the cubic structure, wherein the meta-material pattern comprises six rings with one of the six rings on each one of the six primary surfaces of the cubic structure.

38-40. (canceled)

41. A unit cell structure, comprising:
a cylindrical structure comprising an axially extending centerline and an axially extending cylinder wall; and
a meta-material pattern on the cylinder wall, wherein the meta-material pattern comprises four circumferentially extending and spaced apart rings.

42-45. (canceled)
